(19) United States
(12) Patent Application Publication
(10) Pub. No.: US 2025/0313476 A1
(43) Pub. Date: Oct. 9, 2025

(54) NEGATIVE ACTIVE MATERIAL FOR RECHARGEABLE LITHIUM BATTERY, METHOD OF PREPARING SAME, AND RECHARGEABLE LITHIUM BATTERY INCLUDING SAME

(71) Applicants: SAMSUNG SDI CO., LTD., Yongin-si (KR); IUCF-HYU (Industry-University Cooperation Foundation Hanyang University), Seoul (KR)

(72) Inventors: Ilyoung CHOI, Yongin-si (KR); Deok-Hyun KIM, Yongin-si (KR); Youngugk KIM, Yongin-si (KR); Hansu KIM, Seoul (KR); Mi YU, Seoul (KR); Donghyeok MA, Seoul (KR)

(21) Appl. No.: 19/094,453

(22) Filed: Mar. 28, 2025

(30) Foreign Application Priority Data
Apr. 4, 2024 (KR) 10-2024-0046111

(51) Int. Cl. C01B 32/205; H01M 10/0525

(52) U.S. Cl. CPC C01B 32/205; H01M 10/0525; C01P 2002/72; C01P 2004/03; C01P 2004/84; C01P 2006/40

(57) ABSTRACT

A negative active material, a method of preparing the negative active material, and a rechargeable lithium battery including the negative active material are disclosed. The negative active material may include a crystalline carbon core and a magnesium (Mg)-included coating layer on a surface of the core, wherein the Mg-included coating layer may include MgO and MgₓSiO_{y} (1≤x≤2 and 3≤y≤4).

### CROSS-REFERENCE TO RELATED APPLICATION

The present application claims priority to and the benefit of Korean Patent Application No. 10-2024-0046111, filed on Apr. 4, 2024, in the Korean Intellectual Property Office, the entire disclosure of which is incorporated herein by reference.

### BACKGROUND

### 1. Field

One or more embodiments of the present disclosure relate to a negative active material for a rechargeable lithium battery, a method of preparing the negative active material, and a rechargeable lithium battery including the negative active material.

### 2. Description of the Related Art

With the rapid spread of electronic devices that utilize batteries, e.g., mobile phones, laptop computers, and electric vehicles, it is desirable to develop smaller, lighter, and relatively high-capacity rechargeable lithium batteries. Improving or enhancing performances of rechargeable lithium batteries has been considered.

Rechargeable lithium batteries include a positive electrode and a negative electrode including an active material capable of intercalating and deintercalating lithium ions, and an electrolyte solution, and electrical energy is produced by oxidation and reduction reactions if (e.g., when) lithium ions are intercalated/deintercalated at the positive and negative electrodes.

### SUMMARY

One or more aspects of embodiments of the present disclosure are directed toward a negative active material for a rechargeable lithium battery exhibiting improved or enhanced charge and discharge characteristics and cycle-life characteristics.

One or more aspects of embodiments of the present disclosure are directed toward a method of preparing or providing the negative active material.

One or more aspects of embodiments of the present disclosure are directed toward a rechargeable lithium battery including the negative active material.

One or more aspects of embodiments of the present disclosure are directed toward a negative active material including a crystalline carbon core; and a magnesium (Mg)-included coating layer on a surface of the core, wherein the Mg-included coating layer includes MgO and MgₓSiO_{y} (1≤x≤2 and 3≤y≤4).

One or more aspects of embodiments of the present disclosure are directed toward a method of preparing or providing a negative active material, including adding crystalline carbon to an acidic solvent (e.g., a proton (H⁺) donor) to prepare a mixed liquid; adding a hydrogen silsesquioxane precursor to the mixed liquid to prepare a mixture; primarily heat-treating the mixture to prepare a primarily heat-treated product; mixing the primarily heat-treated product with a Mg source material to prepare a mixed product; and secondarily heat-treating the mixed product.

One or more aspects of embodiments of the present disclosure are directed toward a rechargeable lithium battery including a negative electrode including the negative active material; a positive electrode; and a non-aqueous (e.g., water-insoluble) electrolyte.

A negative active material according to one or more embodiments may exhibit improved or enhanced charge and discharge characteristics and cycle-life characteristic.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1-4 each is a cross-sectional view schematically illustrating rechargeable lithium batteries according to one or more embodiments.

FIG. 5 is a graph illustrating an X-ray diffraction (XRD) peak measurement for the negative active materials of Examples 1 to 4 and Comparative Examples 1 and 2.

FIG. 6 is a graph illustrating an X-ray diffraction peak measurement for the negative active materials of Examples 3 and 5 and Comparative Example 1.

FIG. 7 is a scanning electron microscopic (SEM) image of the negative active materials of Comparative Examples 1 and 2.

FIG. 8 is a SEM image of the negative active materials of Examples 1 to 4.

FIG. 9 is a SEM image of the negative active materials of Comparative Example 1 and Examples 3 and 5.

FIG. 10 is a SEM image of the negative active materials of Example 3 and the EDS analysis result thereof.

### DETAILED DESCRIPTION

Hereinafter, embodiments of the present disclosure will be described in more detail. However, these embodiments are examples, the present disclosure is not limited thereto, and the present disclosure is defined by the scope of the appended claims and equivalents thereof.

As utilized herein, the singular forms “a,” “an,” and “the” are intended to include the plural forms as well, unless the context clearly indicates otherwise. Further, the utilization of “may” when describing embodiments of the present disclosure refers to “one or more embodiments of the present disclosure.”

In the context of the present disclosure and unless otherwise defined, the terms “use,” “using,” and “used” may be considered synonymous with the terms “utilize,” “utilizing,” and “utilized,” respectively.

As utilized herein, the term “about” or similar terms are used as terms of approximation and not as terms of degree, and are intended to account for the inherent deviations in measured or calculated values that would be recognized by those of ordinary skill in the art. “About” or “approximately,” as used herein, is also inclusive of the stated value and refers to within an acceptable range of deviation for the particular value as determined by one of ordinary skill in the art, considering the measurement in question and the error associated with measurement of the particular quantity (e.g., the limitations of the measurement system). For example, “about” may refer to within one or more standard deviations, or within ±30%, ±20%, ±10%, or ±5% of the stated value.

As used herein, if (e.g., when) a definition is not otherwise provided, it will be understood that if (e.g., when) an element, such as a layer, a film, a region, a substrate, and/or the like, is referred to as being “on” another element, it may be directly on the other element or intervening elements may also be present. In contrast, if (e.g., when) an element is referred to as being “directly on” another element, there are no intervening elements present.

Unless otherwise specified in the specification, expressions in the singular include expressions in plural. Unless otherwise specified, “A or B” may refer to “includes A, includes B, or includes A and B”.

Any numerical range recited herein is intended to include all sub-ranges of substantially the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend the present disclosure, including the appended claims, to expressly recite any sub-range subsumed within the ranges expressly recited herein.

As used herein, the term “combination thereof” may include a mixture, a laminate, a complex, a copolymer, an alloy, a blend, a reactant of constituents, and/or reaction product of reactants.

As used herein, if (e.g., when) a definition is not otherwise provided, a particle diameter may be an average particle diameter. Such a particle diameter may refer to an average particle diameter (D50) where a cumulative volume is about 50 volume % in a particle size distribution. The particle size (D50) may be measured by a method generally used by or generally available to those skilled in the art, for example, by a particle size analyzer, and/or by a transmission electron microscopic (TEM) image, and/or a scanning electron microscopic (SEM) image. In one or more embodiments, a dynamic light-scattering (DLS) measurement device may be used to perform a data analysis, and the number of particles may be counted for each particle size range, and from this information, the average particle diameter (D50) value may be obtained through a calculation.

The particle size may be measured by a laser diffraction method. The laser diffraction may be obtained by distributing particles to be measured in a distribution solvent and introducing or providing it to a commercially available laser diffraction particle measuring device (e.g., MT 3000 available from Microtrac, Inc.), irradiating ultrasonic waves of about 28 kHz at a power of about 60 W, and calculating an average particle diameter (D50) in the 50% standard of particle distribution in the measuring device.

In one or more embodiments, an average particle diameter may be measured by one or more suitable techniques, and for example, may be measured by a particle size analyzer.

In one or more embodiments, a thickness may be measured by a SEM image and/or a TEM image for the cross-section, but is not limited thereto, and it may be measured by any suitable techniques, as long as it may measure a suitable thickness in the related arts. The thickness may be an average thickness.

As used herein, soft carbon refers to graphitizable carbon materials and may be readily or suitably graphitized by heat treatment at a high temperature, e.g., about 2800° C., and hard carbon refers to non-graphitizable carbon materials and may be not substantially and slightly graphitized by heat treatment. The terms “soft carbon” and “hard carbon” may be generally used or referred to in the related arts.

In one or more embodiments, the crystalline carbon and the amorphous carbon may be distinguished from each other through X-ray diffraction (XRD) measurement. The crystalline carbon may include natural graphite and/or artificial graphite. Natural graphite may refer to graphite which may be naturally generated by separating it from minerals, and if (e.g., when) measured by XRD, the interplanar spacing (d002) of the (002) plane may be about 3.350 Å to about 3.359 Å. Artificial graphite may refer to graphite manufactured by graphitization, and if (e.g., when) measured by XRD, the interplanar spacing (d002) of the (002) plane may be about 3.360 Å to about 3.369 Å. In one or more embodiments, the amorphous carbon may have the interplanar spacing (d 002) of the (002) plane of about 3.44 Å or more, if (e.g., when) measured by XRD. The XRD may be measured by using CuKα ray as a target ray with an X-ray diffraction analyzer (e.g., product name: X'Pert, manufacturer: Malvern Panalytical) and by removing a monochromator to improve or enhance a peak density resolution. The measurement condition may be 2θ of 10° to 80°, a scan speed (°/S) of 0.044 to 0.089, and a step size (°/step) of 0.013 to 0.039.

A negative active material according to one or more embodiments may include a crystalline carbon core and a magnesium (Mg)-included coating layer on the core, wherein the Mg-included coating layer may include MgO and MgₓSiO_{y} (1≤x≤2 and 3≤y≤4).

The negative active material including the Mg-included coating layer including MgO and MgₓSiO_{y} (1≤x≤2 and 3≤y≤4) may enhance energy density and may exhibit improved or enhanced initial efficiency (e.g., percentage value of discharge capacity/charge capacity). For example, the coating of silicon oxide on crystalline carbon may improve or enhance energy density, but it may cause a reduction in initial efficiency (e.g., percentage value of discharge capacity/charge capacity), and these shortcomings may be prevented or reduced by adding Mg.

The negative active material according to one or more embodiments may include crystalline carbon as a core and the Mg-included coating layer on the surface of the core, and thus, the crystalline carbon and Mg may exist in different positions or locations. If (e.g., when) the crystalline carbon and Mg exist in substantially the same position or location (e.g., positioned or located on the core together with), or if (e.g., when) Mg is included in the core, rather than the coating layer (e.g., a negative active material including a Mg-included core and a crystalline carbon coating layer on the surface of the core), the improvement or enhancement in the cycle-life characteristics may be not realized or provided, due to the expansion of the Si-included material.

In one or more embodiments, the negative active material may have a first peak appearing at 2θ of 40° to 50° and a second peak appearing at 2θ of 30° to 40° in an X-ray diffraction analysis using a CuKα ray.

The first peak may be a peak related to MgO, and the first peak may appear at 2θ of 41° to 45° or 42° to 43°.

The second peak may be a peak related to MgₓSiO_{y} (1≤x≤2 and 3≤y≤4), and the second peak may appear at 2θ of 32° to 38° or 35° to 37°.

The negative active material may have a third peak appearing at 2θ of about 25° to about 35° in an X-ray diffraction analysis using a CuKα ray. The third peak may be a peak related to Si, and the third peak may appear at 2θ of about 27° to about 33° or about 28° to about 30°.

The appearance of the first peak and the second peak in the X-ray diffraction analysis for the negative active material using a CuKα ray may represent that the negative active material includes MgO and MgₓSiO_{y} (1≤x≤2 and 3≤y≤4). The appearance of the third peak may represent that the negative active material includes Si.

The XRD may be measured by using CuKα ray as a target ray with an X-ray diffraction analyzer (e.g., product name: SmartLab, manufacturer: Rigaku) and by removing a monochromator to improve or enhance a peak density resolution. The measurement condition may be 20 of 10° to 90°, a scan speed (s/step) of 0.2 to 0.6, and a step size (°/step) of 0.013 to 0.039.

### Mg-Included Coating Layer

In the negative active material according to one or more embodiments, the MgₓSiO_{y} included in the Mg-included coating layer may be Mg₂SiO₄, MgSiO₃, or a combination thereof, and in one or more embodiments, it may be Mg₂SiO₄ with respect to capacity increase effect.

In one or more embodiments, the Mg-included coating layer may further include crystalline Si. If (e.g., when) the Mg-included coating layer further includes crystalline Si, more excellent or suitable electrochemical performances may be exhibited or obtained. If (e.g., when) the Mg-included coating layer also includes amorphous Si, it may be inappropriate or unsuitable due to the potential decreases or reduction in electrical conductivity, mechanical strength, and/or the like, which may deteriorate or reduce electrochemical performances.

A thickness of the Mg-included coating layer may be about 150 nm to about 500 nm, about 150 nm to about 400 nm, or about 200 nm to about 350 nm. The thickness of the coating layer may be an average thickness. If (e.g., when) the thickness of the Mg-included coating layer is within the foregoing ranges, high capacity retention may be secured or obtained, and energy density and relatively high rate chargeability may be enhanced.

In one or more embodiments, the Mg-included coating layer may be discontinuously (e.g., substantially discontinuously) provided on the surface of the core in a form of an island-type or -kind or continuously (e.g., substantially continuously) provided on the surface of the core in a form of a layer-type or -kind. For example, some of the surface of the core may not be covered (e.g., the surface of the core may be partially covered) by the Mg-included coating layer to partially expose the core, or the entire surface of the core may be covered by the Mg-included coating layer not to expose the core. In one or more embodiments, if (e.g., when) the Mg-included coating layer is provided in the form of the island-type or -kind, superior or suitable conductivity (e.g., electrical conductivity) may be exhibited or obtained, thereby demonstrating more excellent or suitable rate capability and efficiency (e.g., electrical efficiency) characteristic.

The Mg-included coating layer may be porous. If (e.g., when) the Mg-included coating layer is porous, an irreversible phase which does not react with lithium may not be present, and thus, the advantages or features with respect to energy density may be exhibited or obtained compared to the Mg-included coating layer being a dense layer.

### Core

The negative active material according to one or more embodiments may include the crystalline carbon core, and the crystalline carbon core may be unspecified shaped (e.g., amorphously shaped), and/or sheet (e.g., substantially sheet), flake (e.g., substantially flake), spherical (e.g., substantially spherical), and/or fiber (e.g., substantially fiber) shaped natural graphite and/or artificial graphite.

### Carbon Coating Layer

The negative active material according to one or more embodiments may further include a carbon coating layer on the Mg-included coating layer.

The carbon coating layer may include crystalline carbon, amorphous carbon, or a combination thereof.

The crystalline carbon may be unspecified shaped (e.g., amorphously shaped), and/or sheet (e.g., substantially sheet), flake (e.g., substantially flake), spherical (e.g., substantially spherical), and/or fiber (e.g., substantially fiber) shaped natural graphite and/or artificial graphite.

The amorphous carbon may be pitch carbon, soft carbon, hard carbon, mesophase pitch carbide, sintered coke, carbon fiber, or a combination thereof.

The carbon coating layer may have a thickness of 0.1 nm to 20 nm, 0.5 nm to 10 nm, or 1 nm to 5 nm. If (e.g., when) the thickness of the carbon coating layer is within the foregoing ranges, the electrical conductivity may be enhanced, thereby securing or obtaining excellent or suitable electrochemical performances.

In one or more embodiments, the carbon coating layer may be positioned or arranged by substantially totally (e.g., substantially completely) surrounding or covering the surface of the Mg-included coating layer. For example, if (e.g., when) the Mg-included coating layer substantially totally (e.g., substantially completely) surrounds or covers the surface of the core, the carbon coating layer may also be positioned or arranged by substantially totally (e.g., substantially completely) surrounding or covering the surface of the coating the Mg-included coating layer, and thus, the surface of the core may not be exposed. In one or more embodiments, if (e.g., when) the Mg-included coating layer partially covers the surface of the core, even though the carbon coating layer completely (e.g., substantially completely) surrounds or covers the Mg-included coating layer, some parts of the core may still be exposed to outside (e.g., the surface of the core may be partially covered).

The carbon coating layer may have porous. If (e.g., when) the carbon coating layer has porous, there may be no irreversible phases which do not react with lithium, and thus, it may be advantageous or beneficial with respect to an energy density compared to the Mg-included coating layer being a dense layer.

### Negative Active Material Composition

If (e.g., when) the negative active material according to one or more embodiments includes the crystalline carbon core and the Mg-included coating layer on the core, an amount of the Mg-included coating layer may be, based on 100 wt % of a total amount of the negative active material, about 5 wt % to about 30 wt %, about 10 wt % to about 25 wt %, or about 15 wt % to about 20 wt %. If (e.g., when) the amount of the Mg-included coating layer is within the foregoing ranges, excellent or suitable initial efficiency (e.g., percentage value of discharge capacity/charge capacity) may be exhibited or obtained.

An amount of the crystalline carbon may be about 70 wt % to about 95 wt %, about 75 wt % to about 90 wt %, or about 80 wt % to about 85 wt %, based on 100 wt % of a total amount of the negative active material.

In one or more embodiments, if (e.g., when) the negative active material includes the crystalline carbon core, the Mg-included coating layer on the core, and a carbon coating layer on the Mg-included coating layer, an amount of the Mg-included coating layer may be, based on 100 wt % of a total amount of the negative active material, about 5 wt % to about 30 wt %, about 10 wt % to about 25 wt %, or about 15 wt % to about 20 wt %. An amount of the crystalline carbon core may be, based on 100 wt % of a total amount of the negative active material, about 55 wt % to about 85 wt %, about 60 wt % to about 80 wt %, or about 65 wt % to about 75 wt %.

An amount of the carbon coating layer may be, based on 100 wt % of a total amount of the negative active material, about 1 wt % to about 25 wt %, about 3 wt % to about 20 wt %, or about 5 wt % to about 15 wt %.

In one or more embodiments, if (e.g., when) the amount of the Mg-included coating layer included in the negative active material satisfies in or is within the foregoing ranges, each amount of MgO and MgₓSiO_{y} (1≤x≤2 and 3≤y≤4) may not be necessarily limited.

If (e.g., when) the amount of the Mg-included coating layer satisfies in or is within the foregoing ranges, excellent or suitable initial efficiency (e.g., percentage value of discharge capacity/charge capacity) may be exhibited or obtained. The inclusion of the crystalline carbon core within the foregoing ranges may provide excellent or suitable cycle-life characteristic, enhanced initial efficiency (e.g., percentage value of discharge capacity/charge capacity), and/or the like. If (e.g., when) the amount of the carbon coating layer satisfies in or is within the foregoing ranges, the electrical conductivity may be improved or enhanced.

### Method of Preparing Negative Active Material

The negative active material according to one or more embodiments may be prepared by adding crystalline carbon to an acidic solvent (e.g., a proton (H⁺) donor) to prepare a mixed liquid; adding a hydrogen silsesquioxane precursor to the mixed liquid to prepare a mixture; primarily heat-treating the mixture to prepare a primarily heat-treated product; mixing the primarily heat-treated product with a Mg source material to prepare a mixed product; and secondarily heat-treating the mixed product. Hereinafter, embodiments of the preparation will be illustrated in more detail.

Crystalline carbon may be added to an acidic solvent (e.g., a proton (H⁺) donor) to prepare a mixed liquid. A hydrogen silsesquioxane precursor may be added to the mixed liquid to prepare a mixture. The acidic solvent may be hydrochloric acid, sulfuric acid, acetic acid, or a combination thereof. The acidic solvent may be an aqueous (e.g., water-soluble) solution having a concentration of about 0.05 M to about 0.5 M (e.g., may be an aqueous solution having a concentration of about 0.05 M to about 0.5 M of hydrochloric acid, sulfuric acid, acetic acid, or a combination thereof).

The crystalline carbon may be graphite, such as an unspecified shaped (e.g., amorphously shaped), sheet shaped (e.g., substantially sheet shaped), flake shaped (e.g., substantially flake shaped), spherical shaped (e.g., substantially spherical shaped), and/or fiber shaped (e.g., substantially fiber shaped) artificial graphite and/or natural graphite.

An added amount of the crystalline carbon may be, per about 10 ml of the solvent, about 0.1 g to about 10 g, about 0.2 g to about 10 g, or about 0.5 g to about 5 g.

After adding the crystalline carbon to the acidic solvent, a shaking may be carried out at a rate of about 200 rpm to about 1000 rpm, about 300 rpm to about 1000 rpm, or about 500 rpm to about 1000 rpm for about 10 minutes to about 1 hour or about 20 minutes to about 40 minutes.

The addition of the hydrogen silsesquioxane precursor may be carried out while shaking at a rate of about 200 rpm to about 1000 rpm, about 300 rpm to about 1000 rpm, or about 500 rpm to about 1000 rpm.

The hydrogen silsesquioxane precursor may be triethoxysilane, trimethoxysilane, vinyl trimethoxysilane, vinyltriethoxysilane, γ-methacryloxy propyltrimethoxysilane, γ-methacryloxy propyltriethoxysilane, or a combination thereof.

An addition amount of the hydrogen silsesquioxane precursor may be suitably adjusted in order to have a weight ratio of the shell/core to be about 1:100 to about 30:100 by weight ratio, about 5:100 to about 25:100 by weight ratio, or about 10:100 to about 20:100 by weight ratio in the primarily heat-treated product.

The mixing may cause a sol-gel reaction, thereby preparing or providing a product in which hydrogen silsesquioxane precursor is coated on the surface of the carbon-based material.

Thereafter, the resulting product may be primarily heat-treated. The primarily heat-treat treatment may be carried out by increasing the temperature to about 800° C. to about 1500° C. or about 900° C. to about 1300° C. at an increasing rate of about 1° C./minute to about 20° C./minute or about 2° C./minute to about 15° C./minute, and then maintaining that temperature for about 0.5 hours to about 5 hours or about 0.5 hours to about 3 hours. The primarily heat-treatment may be carried out under the inert atmosphere, and the inert atmosphere may be argon, nitrogen, hydrogen, or a mixed atmosphere thereof.

The primarily heat-treatment may cause decomposition of the hydrogen silsesquioxane precursor thereby preparing or providing silicon, and thus, a product including the carbonaceous material core and a silicon shell on the core may be prepared. In one or more embodiments, if (e.g., when) the heat treatment temperature is suitably adjusted, a shell including silicon together with SiO_{z} (0<z≤2) may be prepared. In one or more embodiments, the prepared silicon may be amorphous silicon.

The primarily heat-treated and a Mg source material may be mixed to prepare a mixed product.

In the mixing, an amount of the Mg source material may be suitably adjusted in order to have a mole ratio of Mg/Si to be about 0.2 to about 1.2, about 0.25 to about 1.0, or about 0.75 to about 1.0 in the negative active material. If (e.g., when) the amount of the Mg source material is within the foregoing ranges, crystalline Si and the Mg-included coating layer may be appropriately or suitably formed, thereby more enhancing capacity (e.g., electrical capacity) and cycle-life characteristic.

The Mg source material may be MgH₂, Mg, MgOH, MgCl₂, MgSi, or a combination thereof.

The mixing may be carried out by using a ball mil, and the ball mill may utilize zirconia balls, but it is not limited thereto.

In one or more embodiments, before mixing with the Mg source material, a formation of carbon coating layer on the primarily heat-treated product may be further carried out. The formation of the coating layer may be carried out by mixing the primarily heat-treated product with a carbon precursor and heat-treating. The carbon precursor may include petroleum coke, coal coke, petroleum pitch, coal pitch, pitch carbon, green cokes, or a combination thereof.

A mixing ratio of the primary heat-treated product and the carbon precursor may be a weight ratio of about 7:3 to about 9.5:0.5.

The mixing may be performed in a solvent, and the solvent may be tetrahydrofuran, methanol, ethanol, propanol, water, or a combination thereof. The mixing may be performed at about 40° C. to about 80° C. or about 50° C. to about 70° C. and at a speed of about 100 rpm to about 200 rpm or about 110 rpm to about 150 rpm, until the solvent is substantially and mostly removed (e.g., until the solvent is substantially and mostly dried).

After mixing with the carbon precursor, the heat treatment may be carried out by increasing the temperature at an increasing rate of about 1° C./minute to about 10° C./minute or about 2° C./minute to about 8° C./minute to about 500° C. to about 3300° C. or about 600° C. to about 3000° C. and maintaining that temperature for about 1 hour to about 8 hours or about 1 hour to about 5 hours.

To the resulting mixture, heating inhibitor may be added. Before adding the heating inhibitor, a pulverization may be further carried out.

The heating inhibitor may be NaCl, KCl, CaCl₂), or a combination thereof. An amount of the heating inhibitor may be, based on 100 parts by weight of the product, about 250 parts by weight to about 350 parts by weight, about 270 parts by weight to about 330 parts by weight, or about 290 parts by weight to about 310 parts by weight.

The heating inhibitor may suppress or reduce the extreme heat generation which may be occurred in the subsequent heat treatment, and thus, the explosive increases in the Si crystal and/or the extreme formation of MgO may be prevented or reduced.

A secondarily heat-treatment may be carried out to prepare a negative active material.

The secondarily heat treatment process may be carried out by increasing the temperature at an increasing rate of about 1° C./minute to about 20° C./minute or about 2° C./minute to about 15° C./minute to about 500° C. to about 1000° C. or about 600° C. to about 900° C. and maintaining that temperature for about 1 hour to about 10 hours or about 2 hours to about 8 hours. The secondarily heat-treatment may be carried out under an inert atmosphere, and the inert atmosphere may be an argon atmosphere, a nitrogen atmosphere, a hydrogen atmosphere, or a mixture thereof.

According to the secondarily heat-treatment, Mg ions derived from the Mg source material may be doped into SiO_{z} (0<z≤2) of the silicon shell to generate MgₓSiO_{y} (1≤x≤2 and 3≤y≤4). The doping of Mg ions may be appropriately or suitably carried out by using a Mg source material powder, e.g., a compound in the form of powder, as the doping may be more uniformly (e.g., substantially uniformly) occurred.

In the secondarily heat-treatment, heat may be generated, enabling conversion of the amorphous silicon prepared by the primarily heat-treatment into a crystalline silicon. In one or more embodiments, in the secondarily heat-treatment, if (e.g., when) heat is largely generated or the Mg ions are formed at a high concentration, MgO may be also formed.

Even though the formation of the carbon coating layer may be carried out, the Mg ions may be passed through the carbon coating layer and doped to SiO_{z} (0<z≤2) of the silicon shell. In more detail, the Mg source material in the form of a solid state may be subjected to a phase transition into a vapor state, thereby generating Mg ions which may be passed through the amorphous carbon coating layer to react with SiO_{z} (0<z≤2), thereby forming or providing a Mg-included coating layer between the core (e.g., crystalline carbon core) and the carbon coating layer.

As a result, the Mg-included coating layer including MgO and MgₓSiO_{y} (1≤x≤2 and 3≤y≤4) may be prepared on the crystalline carbon core.

From the heat-treated product, the heating inhibitor may be removed. The heating inhibitor removal may be carried out by physical techniques, such as use of spatula spoon and/or the like.

Thereafter, the resulting product may be pulverized.

The obtained product may also be subjected to a further process including cleaning and drying. The cleaning may be carried out by using water and/or a weak acidic solvent, and in one or more embodiments, it may be carried out by using a weak acidic solvent. The weak acidic solvent may be phosphoric acid (H₃PO₄), acetic acid, or a combination thereof.

### Rechargeable Lithium Battery

One or more embodiments of the present disclosure provide a rechargeable lithium battery including a negative electrode including the negative active material, a positive electrode, and an electrolyte.

### Negative Electrode

The negative electrode may include a current collector and a negative active material layer on the current collector, where the negative active material layer may include a negative active material according to one or more embodiments. The negative electrode active material layer may include a binder, and may further include a conductive (e.g., electrically conductive) material.

For example, the negative active material layer may include the negative active material at about 90 wt % to about 99 wt % and the binder at about 1 wt % to about 10 wt % or may include the negative active material at about 90 wt % to about 99 wt %, the binder at about 0.5 wt % to about 5 wt %, and the conductive (e.g., electrically conductive) material at about 0.5 wt % to about 5 wt %.

The binder may improve or enhance binding properties of negative active material particles with one another and/or with a current collector. The binder may be a non-aqueous (e.g., water-insoluble) binder, an aqueous (e.g., water-soluble) binder, a dry binder, or combination thereof.

The non-aqueous (e.g., water-insoluble) binder may be polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous (e.g., water-soluble) binder may be a styrene-butadiene rubber (SBR), a (meth)acrylated styrene-butadiene rubber, a (meth)acrylonitrile-butadiene rubber, a (meth)acrylic rubber, a butyl rubber, a fluorine rubber, polyethylene oxide, polyvinyl pyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenolic resin, an epoxy resin, polyvinyl alcohol, or combinations thereof.

The negative electrode binder may include a cellulose compound and may include the cellulose-based compound together with the aqueous (e.g., water-soluble) binder. The cellulose compound may be referred to as a thickener, as it may impart or increase viscosity, and it may be referred to as a binder, as it may serve as a binder. An amount of the cellulose-based compound may be appropriately or suitably adjusted within the amount of the binder and may be not limited. The cellulose compound may include one or more of carboxymethyl cellulose, hydroxypropyl methylcellulose, methyl cellulose, or alkali metal salts thereof. The alkali metal may be sodium (Na), potassium (K), or lithium (Li).

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be included to provide electrode conductivity (e.g., electrical electrode conductivity), and any suitable electrically conductive material may be used as a conductive material unless it causes a chemical change (e.g., unless it causes an undesirable chemical change to the rechargeable lithium battery). Examples of the conductive (e.g., electrically conductive) material may be a carbon-based material, such as natural graphite, artificial graphite, carbon black, acetylene black, Ketjen black, a carbon fiber, a carbon nanofiber, carbon nanotube, and/or the like; a metal-based material of a metal powder or a metal fiber including copper, nickel, aluminum, silver, and/or the like; a conductive (e.g., electrically conductive) polymer, such as polyphenylene or a derivative thereof; or a mixture thereof.

The current collector may include one selected from among a copper foil, a nickel foil, a stainless steel foil, a titanium foil, a nickel foam, a copper foam, a polymer substrate coated with a conductive (e.g., electrically conductive) metal, and a combination thereof, but is not limited thereto.

### Positive Electrode

The positive electrode may include a positive current collector and a positive active material layer on the positive current collector. The positive electrode active material layer may include a positive electrode active material and may further include a binder and/or a conductive (e.g., electrically conductive) material.

For example, the positive electrode may further include an additive that may serve as a sacrificial positive electrode.

An amount of the positive active material may be about 90 wt % to about 99.5 wt % based on 100 wt % of a total amount of the positive active material layer, and amount of the binder and the conductive (e.g., electrically conductive) material each may be 0.5 wt % to 5 wt % based on 100 wt % of a total amount of the positive active material layer.

1 The positive active material may include a compound (e.g., lithiated intercalation compound) that is capable of intercalating and deintercalating lithium. In one or more embodiments, at least one selected from among a composite oxide of lithium and a metal selected from among cobalt, manganese, nickel, or combinations thereof may be used.

The composite oxide may be a lithium transition metal composite oxide, and examples thereof may include lithium nickel-based oxide, lithium cobalt-based oxide, lithium manganese-based oxide, lithium iron phosphate-based compound, cobalt-free nickel-manganese-based oxide, or a combination thereof.

For example, the following compounds represented by any one selected from among the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above chemical formulas, A may be nickel (Ni), cobalt (Co), manganese (Mn), or a combination thereof; X may be aluminum (Al), Ni, Co, Mn, chromium (Cr), iron (Fe), magnesium (Mg), strontium (Sr), vanadium (V), a rare earth element or a combination thereof; D may be oxygen (O), fluorine (F), sulfur(S), phosphorus (P), or a combination thereof; G may be Al, Cr, Mn, Fe, Mg, lanthanum (La), cerium (Ce), Sr, V, or a combination thereof; and L¹ may be Mn, Al, or a combination thereof.

For example, the positive electrode active material may be a highly nickel-based (high-nickel-based) positive electrode active material having a nickel amount of greater than or equal to about 80 mol %, greater than or equal to about 85 mol %, greater than or equal to about 90 mol %, greater than or equal to about 91 mol %, or greater than or equal to about 94 mol %, and less than or equal to about 99 mol % based on 100 mol % of a total amount of the metal excluding lithium in the lithium transition metal composite oxide. The high-nickel-based positive electrode active material may realize or provide high capacity (e.g., electrical capacity) and may be applied to a high-capacity (e.g., high electrical capacity), high-density rechargeable lithium battery.

The binder may improve or enhance binding properties of positive electrode active material particles with one another and with a current collector. Examples of the binder may be polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene butadiene rubber, a (meth)acrylated styrene butadiene rubber, an epoxy resin, a (meth)acrylic resin, a polyester resin, nylon, and/or the like, but are not limited thereto.

The conductive material may be included to provide electrode conductivity (e.g., electrical electrode conductivity), and any suitable electrically conductive material may be used as a conductive material unless it causes a chemical change (e.g., unless it causes an undesirable chemical change to the rechargeable lithium battery). Examples of the conductive (e.g., electrically conductive) material may include a carbon-based material, such as natural graphite, artificial graphite, carbon black, acetylene black, Ketjen black, carbon fiber, carbon nanofiber, carbon nanotube, and/or the like; a metal-based material of a metal powder and/or a metal fiber including copper, nickel, aluminum, silver, and/or the like; a conductive (e.g., electrically conductive) polymer, such as polyphenylene or a derivative thereof; or a mixture thereof.

The current collector may include Al, but is not limited thereto.

### Electrolyte

The electrolyte may include a non-aqueous (e.g., water-insoluble) organic solvent and a lithium salt.

The non-aqueous (e.g., water-insoluble) organic solvent may serve as a medium to transmit ions taking part in the electrochemical reaction of a rechargeable lithium battery.

The non-aqueous (e.g., water-insoluble) organic solvent may include a carbonate-based, ester-based, ether-based, ketone-based, alcohol-based, and/or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like.

The ester-based solvent may include methyl acetate, ethyl acetate, n-propyl acetate, dimethyl acetate, methyl propionate, ethyl propionate, decanolide, mevalonolactone, valerolactone, caprolactone, and/or the like.

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. The ketone-based solvent may include cyclohexanone and/or the like. The alcohol-based solvent may include ethanol, isopropyl alcohol, and/or the like, and the aprotic solvent may include nitriles, such as R—CN (wherein R may be a C2 to C20 linear, branched, or cyclic hydrocarbon group, and may include a double bond, an aromatic ring, and/or an ether bond); amides, such as dimethylformamide; dioxolanes, such as 1,3-dioxolane, 1,4-dioxolane, and/or the like; sulfolanes, and/or the like.

The organic solvent may be used alone or in a mixture of two or more.

If (e.g., when) the carbonate-based solvent is used, the cyclic carbonate and the linear carbonate may be used together therewith, and the cyclic carbonate and the linear carbonate may be mixed at a volume ratio of about 1:1 to about 1:9.

The lithium salt dissolved in an organic solvent may supply a rechargeable lithium battery with lithium ions, operate the rechargeable lithium battery, and improve or enhance transportation of the lithium ions between the positive electrode and the negative electrode. Examples of the lithium salt may include one or at least two supporting electrolyte salt selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂), where x and y may be an integer of 1 to 20, lithium trifluoromethane sulfonate, lithium tetrafluoroethane sulfonate, lithium difluorobis(oxalato)phosphate (LiDFOP), lithium difluorobis(oxalato) borate (LiDFBOB), and lithium bis(oxalato) borate (LiBOB).

### Separator

A separator may be provided between the positive electrode and the negative electrode depending on a type or kind of a rechargeable lithium battery. The separator may use polyethylene, polypropylene, polyvinylidene fluoride or multi-layers thereof having two or more layers and may be a mixed multilayer, such as a polyethylene/polypropylene double-layered separator, a polyethylene/polypropylene/polyethylene triple-layered separator, a polypropylene/polyethylene/polypropylene triple-layered separator, and/or the like.

The separator may include a porous substrate and a coating layer including an organic material, an inorganic material, or a combination thereof on one surface or both surfaces (e.g., two opposing surfaces) of the porous substrate.

The porous substrate may be a polymer film of any one selected from among polyolefin, such as polyethylene and polypropylene, polyester, such as polyethylene terephthalate and polybutylene terephthalate, polyacetal, polyamide, polyimide, polycarbonate, polyether ketone, polyaryletherketone, polyetherimide, polyamideimide, polybenzimidazole, polyethersulfone, polyphenylene oxide, a cyclic olefin copolymer, polyphenylene sulfide, polyethylene naphthalate, a glass fiber, and polytetrafluoroethylene (Teflon™), or a copolymer or mixture of two or more thereof.

The organic material may include a polyvinylidene fluoride-based polymer and/or a (meth)acryl-based polymer.

The inorganic material may be an inorganic particle selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto.

The organic material and an inorganic material may be mixed in one coating layer, or a coating layer including an organic material and a coating layer including an inorganic material may be stacked.

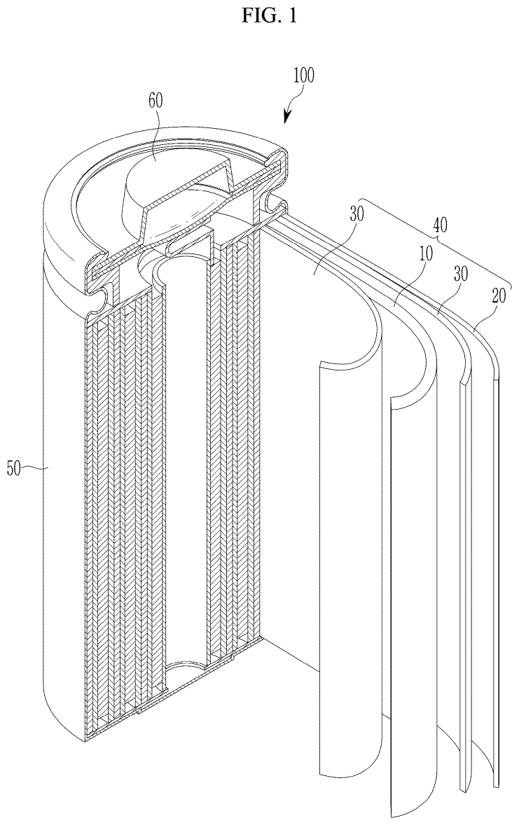

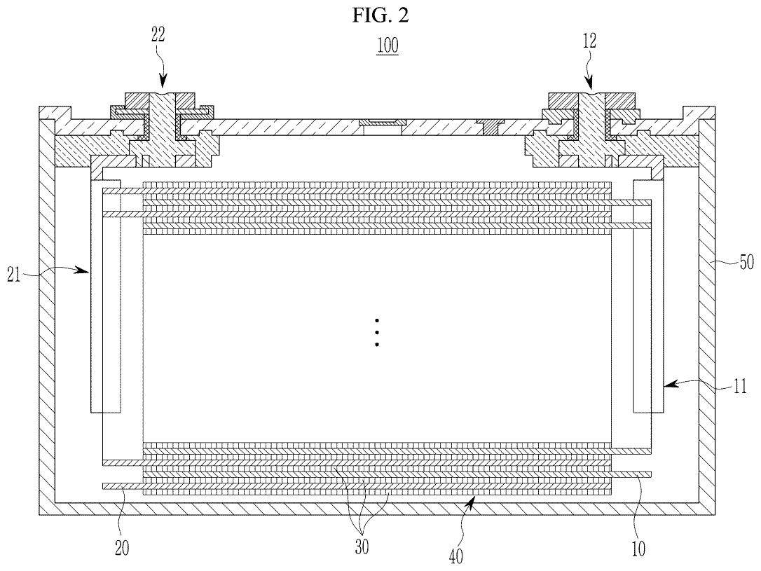

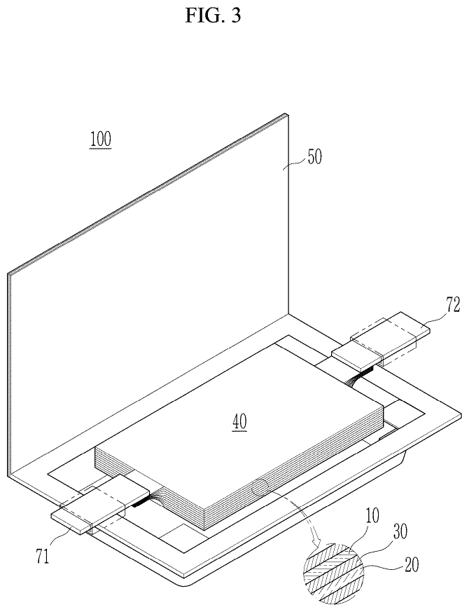

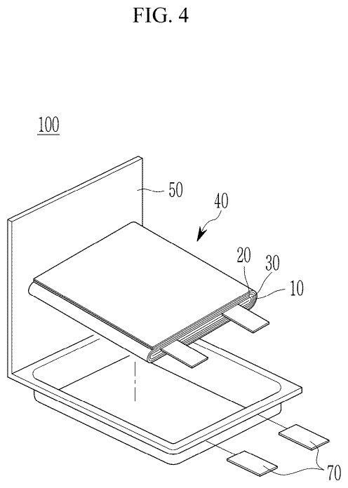

The rechargeable lithium battery may be classified into cylindrical, prismatic, pouch, coin-type or -kind batteries, and/or the like depending on their shape. FIG. 1-4 each is a schematic view illustrating a rechargeable lithium battery according to one or more embodiments. FIG. 1 illustrates a cylindrical battery, FIG. 2 illustrates a prismatic battery, and FIGS. 3 and 4 each illustrates a pouch-type or -kind battery. Referring to FIGS. 1-4, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte. The rechargeable lithium battery 100 may include a sealing member 60 that seals the case 50, as shown in FIG. 2. In FIG. 2, the rechargeable lithium battery 100 may include a positive electrode lead tab 11, a positive terminal 12, a negative electrode lead tab 21, and a negative terminal 22. As shown in FIGS. 3 and 4, the rechargeable lithium battery 100 may include an electrode tab 70, which may serve as an electrical path to induce the current formed in the electrode assembly 40 to the outside, for example, a positive electrode tab 71 and a negative electrode tab 72.

The rechargeable lithium battery according to one or more embodiments may be applied to automobiles, mobile phones, and/or one or more suitable types or kinds of electric devices, as non-limiting examples.

The following Examples and Comparative Examples are provided in order to highlight aspects, features, and characteristics of one or more embodiments, but it will be understood that the Examples and Comparative Examples are not to be construed as limiting the scope of the present disclosure, nor are the Comparative Examples to be construed as being outside the scope of the present disclosure. Further, it will be understood that the embodiments are not limited to the particular details described in the Examples and Comparative Example.

### Example 1

### Preparation of Negative Active Material

### Step 1

5 g of artificial graphite powder was added to 50 mL of a hydrogen chloride (HCl) aqueous solution having a 0.1 M concentration and shaken to prepare a dispersed liquid. Thereafter, while the dispersed liquid was continuously (e.g., substantially continuously) shaken, triethoxysilane (TES) was added to the dispersed liquid and fully reacted.

An added amount of triethoxysilane was 4.071 g in order to have a weight ratio of a shell/core to be 20/100 wt % in a primarily heat-treated product. The resulting product was filtrated with a filter to separate the acidic solvent and dried at 80° C. for one day in a convection oven (horizontal furnace).

The dried powder using the horizontal furnace was primarily heat-treated by increasing the temperature at an increasing rate of 10° C./min to 1000° C. and maintaining at 1000° C. for 1 hour under a mixed atmosphere of argon and hydrogen.

Thereafter, the primarily heat-treated powder was collected and pulverized to prepare a product including a graphite core and a shell including silicon and SiO_{z} (0<z≤2).

### Step 2

The primarily heat-treated product was mixed with pitch carbon at a weight ratio of 9:1 in a mortar, the mixed powder was then put into a beaker, mixed in tetrahydrofuran (THF), and stirred until the solvent was dried.

The resulting mixture was pulverized and heat-treated by increasing the temperature at an increasing rate of 5°/min to 800° C. and maintaining at 800° C. for 2 hours under an argon gas atmosphere, thereby preparing or providing a coating layer-included product including an amorphous carbon coating layer on the shell.

### Step 3

The coating layer-included product and a MgH₂ powder were mixed, and zirconia balls were added to the mixture, and then vigorously mixed for 30 minutes. The MgH₂ was used at an amount of 0.048 g in order to have a mole ratio of Mg/Si to be 0.25. The obtained mixture was sieved using a sieve of 500 μm. 2.015 g of the sieved product was put into an alumina crucible and 6 g of NaCl powder was coated thereon.

Thereafter, the obtained product was secondarily heat-treated by increasing the temperature at an increasing rate of 5° C./min to 700° C. and maintaining at 700° C. for 5 hours under an argon atmosphere using a vertical furnace. From the heat-treated product, NaCl was removed using a spatula spoon and pulverized.

### Step 4

A washing was carried out by adding 1 g of the prepared product to 100 mL of distilled water, shaking for 10 minutes, and filtrating with a filter. The resulting powder was dried in a vacuum oven for one day to prepare a negative active material in which NaCl were removed, and a graphite core, a Mg-included coating layer on the core, including MgO, Mg₂SiO₄, and crystalline Si, and a soft carbon coating layer were included.

In the prepared negative active material, an amount of the Mg-included coating layer was 20 wt % based on 100 wt % of a total amount of the negative active material, an amount of the graphite core was 70 wt % based on 100 wt % of a total amount of the negative active material, and an amount of the soft carbon coating layer was 10 wt % based on 100 wt % of a total amount of the negative active material. In the prepared negative active material, a thickness of the Mg-included coating layer was 250 nm, and a thickness of the soft carbon coating layer was 1 nm.

### Preparation of Negative Electrode

90 wt % of the prepared negative active material, 5 wt % of carboxymethyl cellulose, and 5 wt % of a styrene butadiene rubber were mixed in a water solvent to prepare a negative active material layer slurry.

The negative active material layer slurry was coated on a copper (Cu) foil current collector, vacuum-dried at 120° C. for 2 hours, and pressurized to form a negative active material layer having a thickness of 30 μm, thereby preparing or providing a negative electrode.

A polyethylene separator was provided between the negative electrode and a lithium metal counter electrode, and then an electrolyte was injected to fabricate a CR2032 coin cell. The electrolyte was used by adding 10 wt % of fluoroethylene carbonate to 100 wt % of 1 M LiPF₆ dissolved in a mixed liquid of ethylene carbonate and ethylmethyl carbonate (a mixing ratio of ethylene carbonate:ethylmethyl carbonate=3:7 volume ratio).

### Example 2

A negative active material was prepared by substantially the same procedure as in Example 1, except that in mixing of the coating layer-included product and the MgH₂ powder, MgH₂ was used in an amount of 0.096 g in order to have a mole ratio of Mg/Si to be 0.50. In the prepared negative active material, an amount of the Mg-included coating layer was 20 wt % based on 100 wt % of a total amount of the negative active material, an amount of the graphite core was 70 wt % based on 100 wt % of a total amount of the negative active material, and an amount of the soft carbon coating layer was 10 wt % based on 100 wt % of a total amount of the negative active material. In the prepared negative active material, a thickness of the Mg-included coating layer was 250 nm and a thickness of the soft carbon coating layer was 1 nm.

The negative active material was used to fabricate a negative electrode and a half-cell by substantially the same procedure as in Example 1.

### Example 3

A negative active material was prepared by substantially the same procedure as in Example 1, except that in mixing of the coating layer-included product and the MgH₂ powder, MgH₂ was used in an amount of 0.145 g in order to have a mole ratio of Mg/Si to be 0.75. In the prepared negative active material, and an amount of the Mg-included coating layer was 20 wt % based on 100 wt % of a total amount of the negative active material, an amount of the graphite core was 70 wt % based on 100 wt % of a total amount of the negative active material, and an amount of the soft carbon coating layer was 10 wt % based on 100 wt % of a total amount of the negative active material. In the prepared negative active material, a thickness of the Mg-included coating layer was 250 nm and a thickness of the soft carbon coating layer was 1 nm.

The negative active material was used to fabricate a negative electrode and a half-cell by substantially the same procedure as in Example 1.

### Example 4

A negative active material was prepared by substantially the same procedure as in Example 1, except that in mixing of the coating layer-included product and the MgH₂ powder, MgH₂ was used in an amount of 0.193 g in order to have a mole ratio of Mg/Si to be 1.00. In the prepared negative active material, an amount of the Mg-included coating layer was 20 wt % based on 100 wt % of a total amount of the negative active material, an amount of the graphite core was 70 wt % based on 100 wt % of a total amount of the negative active material, and an amount of the soft carbon coating layer was 10 wt % based on 100 wt % of a total amount of the negative active material. In the prepared negative active material, a thickness of the Mg-included coating layer was 250 nm and a thickness of the soft carbon coating layer was 1 nm.

The negative active material was used to fabricate a negative electrode and a half-cell by substantially the same procedure as in Example 1.

### Example 5

### Step 1

5 g of artificial graphite powder was added to 50 ml of a HCl aqueous solution with a 0.1 M concentration and shaken to prepare a dispersed liquid. Thereafter, while the dispersed liquid was continuously (e.g., substantially continuously) shaken, triethoxysilane (TES) was added to the dispersed liquid and fully reacted.

An added amount of triethoxysilane was 1.809 g in order to have a weight ratio of a shell/core to be 10/100 wt % in a primarily heat-treated product. The resulting product was filtrated with a filter to separate the acidic solvent and dried at 80° C. for one day in a convection oven (horizontal furnace).

The dried powder using the horizontal furnace was primarily heat-treated by increasing the temperature at an increasing rate of 10° C./min to 1050° C. and maintaining at 1050° C. for 1 hour under a mixed atmosphere of argon and hydrogen.

Thereafter, the primarily heat-treated powder was collected and pulverized to prepare a product including a graphite core and a shell including silicon and SiO_{z} (0<z≤2).

### Step 2

The primarily heat-treated product was mixed with pitch carbon at a weight ratio of 9:1 in a mortar, the mixed powder was put into a beaker to mix in tetrahydrofuran (THF), and then it was shaken until the solvent was dried.

The resulting mixture was pulverized and heat-treated by increasing the temperature at an increasing rate of 5°/min to 800° C. and maintaining at 800° C. for 2 hours under an argon gas atmosphere, thereby preparing a coating layer-included product including an amorphous carbon coating layer on the shell.

### Step 3

The coating layer-included product and a MgH₂ powder were mixed, and zirconia balls were added to the mixture, and then vigorously mixed for 30 minutes. The MgH₂ was used at an amount of 0.072 g in order to have a mole ratio of Mg/Si to be 0.75. The obtained mixture was sieved using a sieve of 500 μm. 2.015 g of the sieved product was put into an alumina crucible and 6 g of NaCl powder was coated thereon.

Thereafter, the obtained product was secondarily heat-treated by increasing the temperature at an increasing rate of 5° C./min to 700° C. and maintaining it at 700° C. for 5 hours under an argon atmosphere using a vertical furnace. From the heat-treated product, NaCl was removed using a spatula spoon and pulverized.

### Step 4

A washing was carried out by adding 1 g of the prepared product to 100 ml of distilled water, shaking for 10 minutes, and filtrating with a filter. The resulting powder was dried in a vacuum oven for one day to prepare a negative active material in which NaCl were removed, and a graphite core, a Mg-included coating layer on the core, including MgO, Mg₂SiO₄, and crystalline Si, and a soft carbon coating layer were included.

In the prepared negative active material, and amount of the Mg-included coating layer was 10 wt % based on 100 wt % of a total amount of the negative active material, an amount of the graphite core was 80 wt % based on 100 wt % of a total amount of the negative active material, and an amount of the soft carbon coating layer was 10 wt % based on 100 wt % of a total amount of the negative active material. In the prepared negative active material, a thickness of the Mg-included coating layer was 150 nm and a thickness of the soft carbon coating layer was 1 nm.

### Comparative Example 1

97.5 wt % of artificial graphite negative active material, 1 wt % of carboxymethyl cellulose, and 0.5 wt % of a styrene butadiene rubber were mixed in a water solvent to prepare a negative active material layer slurry.

The negative active material layer slurry was coated on a Cu foil current collector, dried, and pressurized to form a negative active material layer, thereby preparing a negative electrode.

### Comparative Example 2

A negative electrode and a half-cell were fabricated by substantially the same procedure as in Example 1, except that the coating layer-including product prepared in the step 2 of Example 1 was used as a negative active material.

### Experimental Example: 1) Evaluation of X-Ray Diffraction Analysis

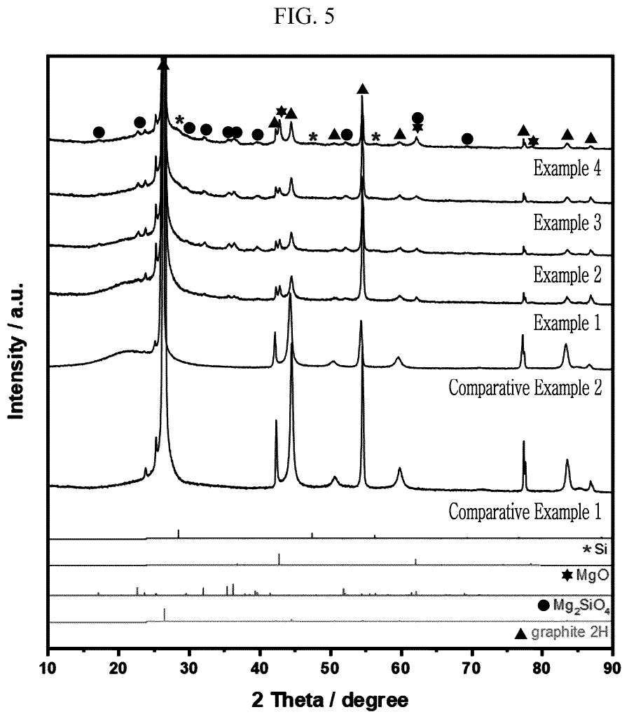

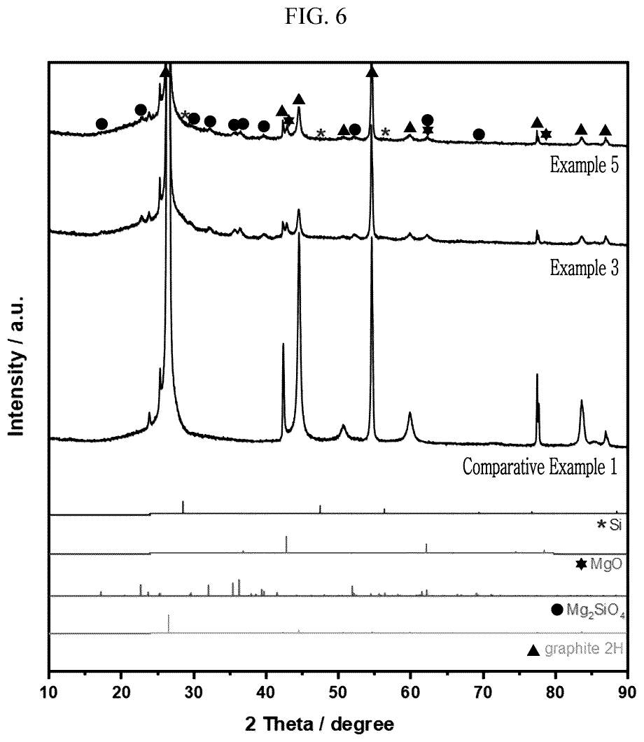

Regarding the negative active materials of Examples 1 to 5 and Comparative Examples 1 and 2, X-ray diffraction (XRD) analysis was determined by using a CuKα ray. Among the results, the results of Examples 1 to 4 and Comparative Examples 1 and 2 are shown in FIG. 5, and the result of Example 5 is shown in FIG. 6. For comparison, the results of Example 3 and Comparative Example 1 are also shown in FIG. 6. The X-ray diffraction analysis was measured by using a CuKα ray as a target ray and a SmartLab (available from Rigaku Corporation) XRD equipment, but by removing monochromator equipment in order to improve a peak intensity resolution. The measurement was performed under a condition of 2θ of 10° to 90°, a speed (s/step) of 0.4, and a step size of 0.02°/step.

The structure phase confirmed from the results shown in FIG. 5 and FIG. 6 are summarized in Table 1.

TABLE 1

| | Mg/Si | |
|---|---|---|
| | mole | |
| | ratio | Phase |
| Example 5 | 0.75 | Si, MgO, Mg₂SiO₄, graphite 2H |
| Example 4 | 1.00 | Si, MgO, Mg₂SiO₄, graphite 2H |
| Example 3 | 0.75 | Si, MgO, Mg₂SiO₄, graphite 2H |
| Example 2 | 0.50 | MgO, Mg₂SiO₄, graphite 2H |
| Example 1 | 0.25 | MgO, Mg₂SiO₄, graphite 2H |
| Comparative Example 2 | — | graphite 2H |
| Comparative Example 1 | — | graphite 2H |

As shown in Table 1, and FIG. 5 and FIG. 6, the negative active materials of Examples 1 to 5 were found to exhibit all MgO, Mg₂SiO₄, and graphite phases and Examples 3 to 5 also exhibited the Si phase.

### Experimental Example: 2) Evaluation of SEM and EDS

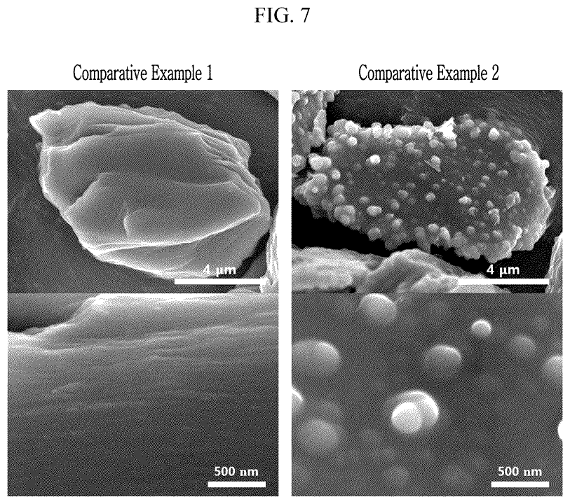

Regarding the negative active materials of Comparative Examples 1 and 2, scanning electron microscope (SEM) image are shown in FIG. 7. From Comparative Example 2 shown in FIG. 7, it had different surface shape from Comparative Example 1.

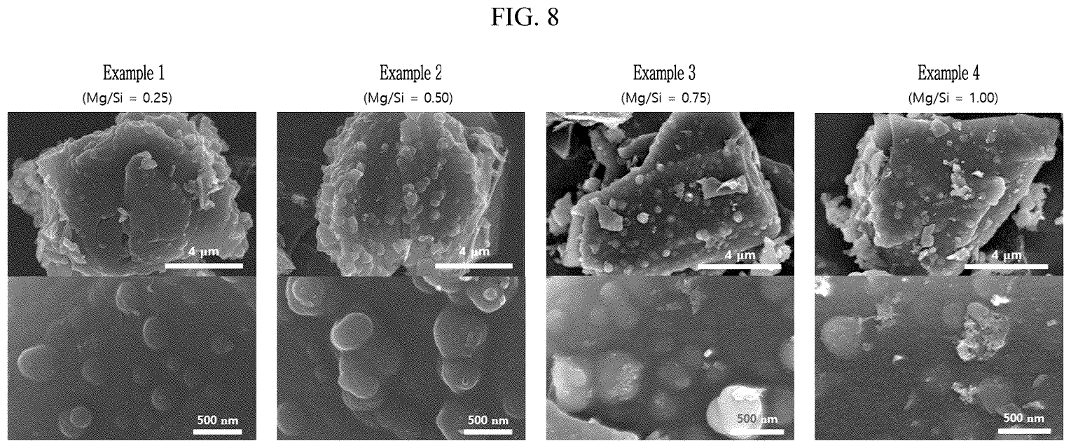

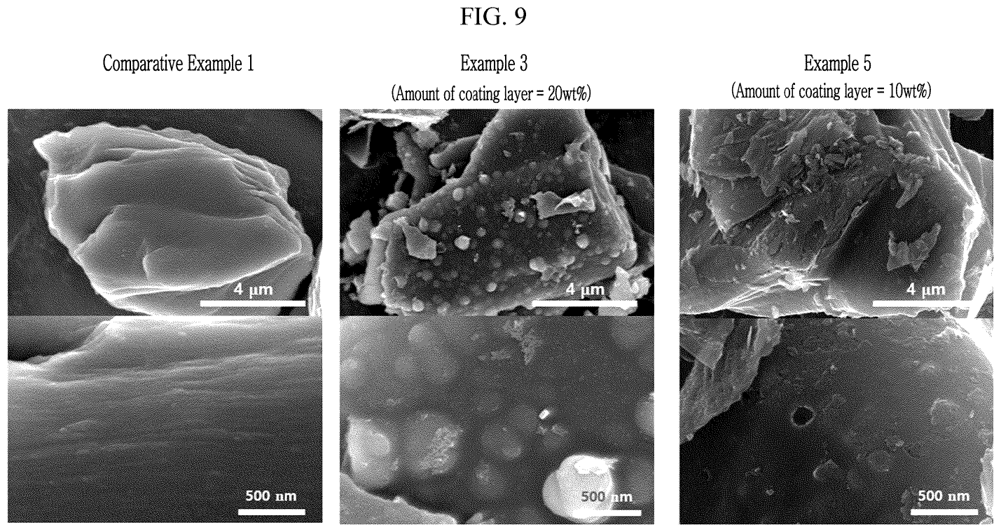

The SEM image for the negative active materials of Examples 1 to 4 is shown in FIG. 8. It is shown in FIG. 8, as the mole ratio of Mg/Si increases, the surface shape is changed. For comparing the shape of the active material shape according to the amount of the coating layer, the SEM images for the negative active materials of Comparative Example 1, Example 3, and Example 5 are shown in FIG. 9. As shown in FIG. 9, Example 3 having the coating layer of 20 wt % and Example 5 with the coating layer of 10 wt % have similar (e.g., substantially similar) surface shape.

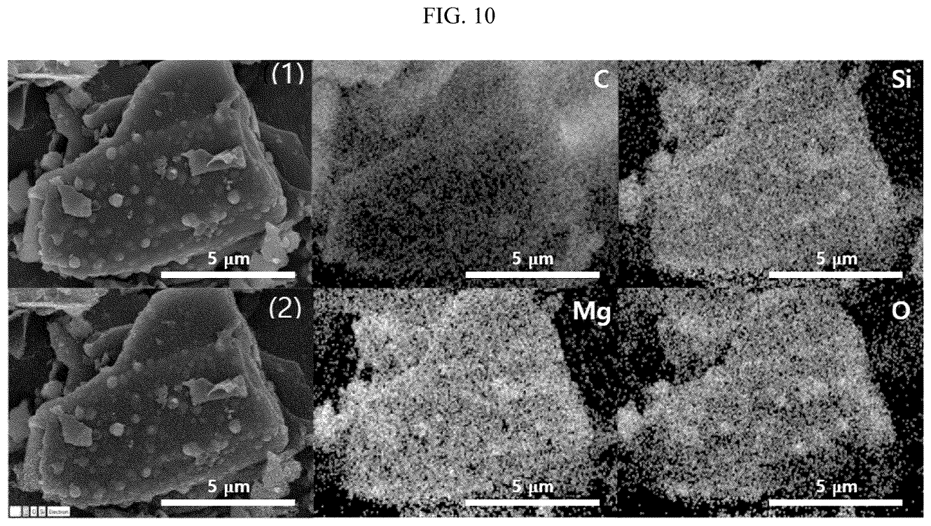

The Energy Dispersive X-Ray Spectroscopy (EDS) for the negative active material of Example 3 is shown in FIG. 10. In FIG. 10, the SEM image of Example 3 shown in FIG. 8 is also shown ((1) of FIG. 10). In FIG. 10, (2) is the result illustrating the distribution of carbon (C), silicon (Si), magnesium (Mg), and oxygen (O) together with the SEM image. As shown in FIG. 10, it was confirmed that Si, Mg and O were uniformly (e.g., substantially uniformly) distributed in the surface of the negative active material according to Example 3, indicating occurrence of magnesium doping by MgH₂.

### Experimental Example: 3) Evaluation of Charge and Discharge Characteristics

The half-cells according to Examples 1 to 5 and Comparative Examples 1 and 2 were formation charged and discharged at a room temperature (25° C.) and at 0.1 C (1 C=360 mAh/g) for 5 cycles. The formation charged and discharged cells were constant current charged at 0.1 C until the voltage reached 0.01 V, followed by a constant voltage charge with a cut-off at a current of 0.01 C while maintaining 0.01 V under a constant voltage mode. Thereafter, until the voltage reached 2.0 V (vs. Li), discharged at 0.1 C was carried out, and constant current charge at 0.5 C was carried out until voltage reached 0.01 V, followed by a constant voltage charge with a cut-off at a current of 0.05 C while maintaining 0.01 V under a constant voltage mode. Thereafter, until the voltage reached to 2.0 V (vs. Li), discharged was proceeded at a constant current of 0.5 C.

After measuring charge capacity and discharge capacity, an initial efficiency (e.g., percentage value of discharge capacity/charge capacity) was obtained from these results. The charge capacities and discharge capacities of Examples 1 to 4 and Comparative Examples 1 and 2 are shown in Table 2. The result of Example 5 is shown in Table 3, and the results of Comparative Example 1 and Example 3 are shown in Table 3.

### Experimental Example: 4) Evaluation of Cycle-Life Characteristic

The half-cells according to Examples 1 to 4 and Comparative Examples 1 and 2, which were subjected to a formation charge and discharge for 5 cycles under the charge and discharge characteristics evaluation conditions, were charged and discharged at 0.5 C for 50 cycles. A ratio of discharge capacity at 50th relative to discharge capacity at 1^{st} (if (e.g., when) the formation charge and discharge cycles were excluded, and at 6^{th} if (e.g., when) the formation charged and discharged cycles were included) was calculated. The results are shown in Table 2, as capacity retention.

The half-cell according to Example 5, which was subjected to the formation charge and discharge for 5 cycles under the condition of the evaluation of charge and discharge characteristics, was charged and discharge at 0.5 C for 18 cycles. A ratio of discharge capacity at 18th relative to discharge capacity at 1^{st} (if (e.g., when) the formation charge and discharge cycles were excluded, and at 6^{th} if (e.g., when) the formation charged and discharged cycles were included) was calculated. The results are shown in Table 3, as capacity retention. A ratio of discharge capacity at 18^{th} relative to 1^{st} discharge capacity of Comparative Example 1 and Example 3 was calculated. The results are shown in Table 3.

TABLE 2

| | Mg/Si | Charge | Discharge | Capacity |
|---|---|---|---|---|
| | mole | capacity | capacity | retention |
| | ratio | (mAh/g) | (mAh/g) | (%) |
| Comparative | — | 349 | 332 | 98.6 |
| Example 1 | | | | |
| Comparative | — | 601 | 440 | 93.8 |
| Example 2 | | | | |
| Example 1 | 0.25 | 556 | 415 | 99.9 |
| Example 2 | 0.50 | 546 | 431 | 99 |
| Example 3 | 0.75 | 549 | 451 | 96.3 |
| Example 4 | 1.0 | 551 | 450 | 95.7 |

TABLE 3

| | Amount of | Charge | Discharge | Capacity |
|---|---|---|---|---|
| | coating layer | capacity | capacity | retention |
| | (wt %) | (mAh/g) | (mAh/g) | (%) |
| Comparative | — | 349 | 332 | 99.4 |
| Example 1 | | | | |
| Example 3 | 20 | 549 | 451 | 97.0 |
| Example 5 | 10 | 415 | 350 | 98.2 |

As shown in Table 2, Comparative Example 2 using the negative active material with silicon shell formed without addition of Mg exhibited a deteriorated capacity retention compared to Comparative Example 1 using artificial graphite negative active material.

Whereas, as shown in Table 2 and Table 3, Examples 1 and 2 using the negative active material with the Mg-included coating layer exhibited excellent charge capacity, discharge capacity, and capacity retention, compared to Comparative Example 1. Examples 3 to 5 exhibited higher charge capacity and discharge capacity than Comparative Example 1 and exhibited excellent capacity retention than Comparative Example 2.

As such, the half-cells of Example 1 to 5 exhibited charge capacity of about 400 mAh/g or more and capacity retention of about 95% or more which indicates excellent capacity characteristic and cycle-life characteristic.

### Experimental Example: 5) Evaluation of Charge Rate Characteristic

The half-cells according to Examples 1 to 5 and Comparative Examples 1 and 2 were formation charged and discharged at a room temperature (25° C.) and at 0.1 C (1 C=360 mAh/g) for 1 cycle. The formation charged and discharged cells were constant current charged at 0.1 C until the voltage reached 0.01 V, followed by a constant voltage charge with a cut-off at a current of 0.01 C while maintaining 0.01 V under a constant voltage mode. Until the voltage reached to 1.5 V (vs. Li), discharged was proceeded at a constant current of 0.2 C.

Thereafter, excepting for the charge current density was changed into 0.2 C, 0.5 C, 1.0 C, and 2.0 C, charge and discharge were carried out under the charge and discharge conditions for 1 cycle at each C-rate.

The charge capacity at each C-rate was measured, and the results are shown in Table 4. In the charge and discharge condition, charge capacity was measured in the constant current range, and the results are shown in parentheses as (XXX).

TABLE 4

| | 0.1 C | 0.2 C | 0.5 C | 1.0 C | 2.0 C |
|---|---|---|---|---|---|
| | (mAh/g) | (mAh/g) | (mAh/g) | (mAh/g) | (mAh/g) |
| Comparative | 344 320 | 342 311 | 342 261 | 341 156 | 341 66 |
| Example 1 | | | | | |
| Comparative | 416 396 | 391 374 | 389 358 | 370 316 | 345 238 |
| Example 2 | | | | | |
| Example 1 | 407 387 | 397 377 | 390 360 | 377 330 | 360 264 |
| Example 2 | 404 387 | 392 374 | 390 359 | 378 336 | 358 269 |
| Example 3 | 441 414 | 439 411 | 437 387 | 436 344 | 434 253 |
| Example 4 | 420 397 | 404 381 | 392 363 | 380 333 | 362 267 |

As shown in Table 4, the cells of Examples 3 and 4 exhibited higher charge capacity than Comparative Examples 1 and 2, particularly very excellent charge capacity than Comparative Examples 1 and 2 at high rates.

The half-cell of Example 1 exhibited higher charge capacity than Comparative Example 1, slightly lower charge capacity than Comparative Example 2 at 0.1 C, but as the C-rate increases, higher charge capacity than Comparative Example 2 exhibited.

The half-cell of Example 2 exhibited higher charge capacity than Comparative Example 1 and exhibited lower charge capacity of Comparative Example 2 at 0.1 C, but as C-rate increases, higher charge capacity was exhibited.

While the subject matter of the present disclosure has been described in connection with what is presently considered to be practical example embodiments, it is to be understood that the present disclosure is not limited to the disclosed embodiments, but, in one or more embodiments, is intended to cover one or more suitable modifications and equivalent arrangements included within the spirit and scope of the appended claims and equivalents thereof. It therefore will be understood that one or more embodiments described above are just illustrative but not limitative in all aspects.

What is claimed is:

1. A negative active material, comprising:
a crystalline carbon core; and
a Mg-included coating layer on a surface of the core,
wherein the Mg-included coating layer comprises MgO and MgₓSiO_{y} (1≤x≤2 and 3≤y≤4).

2. The negative active material as claimed in claim 1, wherein the Mg-included coating layer further comprises crystalline Si.

3. The negative active material as claimed in claim 1, wherein the negative active material has a first peak appearing at 2θ of about 40° to about 50° and a second peak appearing at 2θ of about 30° to about 40° in an X-ray diffraction analysis using a CuKα ray.

4. The negative active material as claimed in claim 1, wherein the negative active material has a third peak appearing at 2θ of about 25° to about 35° in an X-ray diffraction analysis using a CuKα ray.

5. The negative active material as claimed in claim 1, wherein an amount of the Mg-included coating layer is about 5 wt % to about 30 wt % based on 100 wt % of a total amount of the negative active material.

6. The negative active material as claimed in claim 1, wherein the MgₓSiO_{y} is Mg₂SiO₄, MgSiO₃, or a combination thereof.

7. The negative active material as claimed in claim 1, wherein the crystalline carbon core is natural graphite, artificial graphite, or a combination thereof.

8. The negative active material as claimed in claim 1, wherein the Mg-included coating layer has a thickness of 150 nm to 500 nm.

9. The negative active material as claimed in claim 1, wherein the negative active material further comprises a carbon coating layer on the Mg-included coating layer.

10. The negative active material as claimed in claim 9, wherein an amount of the carbon coating layer is about 1 wt % to about 25 wt % based on 100 wt % of a total amount of the negative active material.

11. The negative active material as claimed in claim 9, wherein the carbon coating layer has a thickness of about 0.1 nm to about 20 nm.

12. The negative active material as claimed in claim 9, wherein the carbon coating layer comprises crystalline carbon, amorphous carbon, or a combination thereof.

13. A method of preparing a negative active material, comprising:
adding crystalline carbon to an acidic solvent to prepare a mixed liquid;
adding a hydrogen silsesquioxane precursor to the mixed liquid to prepare a mixture;
primarily heat-treating the mixture to prepare a primarily heat-treated product;
mixing the primarily heat-treated product with a Mg source material to prepare a mixed product; and
secondarily heat-treating the mixed product.

14. The method of preparing the negative active material as claimed in claim 13, wherein a used amount of the Mg source material is adjusted in order to have about 0.2 to about 1.2 of a mole ratio of Mg/Si in the negative active material.

15. The method of preparing the negative active material as claimed in claim 13, wherein the acidic solvent is hydrochloric acid, sulfuric acid, acetic acid, or a combination thereof.

16. The method of preparing the negative active material as claimed in claim 13, wherein the hydrogen silsesquioxane precursor is triethoxysilane, trimethoxysilane, vinyltrimethoxysilane, vinyltriethoxysilane, γ-methacryloxy propyltrimethoxysilane, γ-methacryloxy propyltriethoxysilane, or a combination thereof.

17. The method of preparing the negative active material as claimed in claim 13, wherein the primarily heat-treat treatment is carried out by increasing a temperature to about 800° C. to about 1500° C. at an increasing rate of about 1° C./minute to about 20° C./minute.

18. The method of preparing the negative active material as claimed in claim 13, wherein the secondary heat treatment is carried out by increasing a temperature at an increasing rate of about 1° C./minute to about 20° C./minute to about 500° C. to about 1000° C.

19. The method of preparing the negative active material as claimed in of claim 13, wherein
before mixing with the Mg source material, a formation of carbon coating layer is further carried out.

20. A rechargeable lithium battery, comprising:
a negative electrode comprising the negative active material of claim 1;
a positive electrode; and
a non-aqueous electrolyte.
